(19) United States
(12) Patent Application Publication
(10) Pub. No.: US 2002/0113377 A1
(43) Pub. Date: Aug. 22, 2002

(54) Gas seal

(75) Inventor: Robert McGowan Mann, Exeter (GB)

Correspondence Address: Paul F. Wille, 6407 East Clinton Street, Scottsdale, AZ, 85254, US

(73) Assignee: Lorient Polyproducts Limited, Newton Abbot (GB)

(21) Appl. No.: 10/060,876

(22) Filed: Jan. 30, 2002

(30) Foreign Application Priority Data
Dec. 3, 2001 (GB) 0128838.0
Feb. 1, 2001 (GB) 0102552.7

(51) Int. Cl. F16J 15/02

(52) U.S. Cl. 277/628

(57) ABSTRACT

A gas seal for providing a seal between a frame and a movable member mounted on the frame, the gas seal comprising an elongate support member having opposed upper and lower faces and opposed first and second sides, and a sealing lip extending along and being joined to the support member, the sealing lip having an anchor portion and a sealing portion, the sealing portion being spaced from the support member by said anchor portion and having an edge which defines a terminal sealing edge of said sealing lip, the sealing lip normally residing in an inoperative position and being movable relative to the support member to an operative position, said anchor and sealing portions extending laterally from the first side when the sealing lip resides in said inoperative position whereas when the sealing lip resides in said operative position said anchor portion resides in face to face contact with said first side with said seal portion projecting laterally beyond the upper face of said support member.

### BACKGROUND OF THE INVENTION

The present invention relates to a gas seal for providing a seal between a frame and a movable member mounted on the frame. In particular, the invention relates to a smoke seal and more particularly a smoke seal in combination with a fire seal.

Combined fire and smoke seals are known. Usually they comprise an elongate body which is usually located in a groove formed in the frame or movable member, such as a door, with the upper face of the body exposed. The body houses an intumescent material which in the event of a fire intumesces to form a fire seal. A sealing lip is usually mounted on the elongate body to extend across a gap between the frame and door, and so provide a smoke seal.

In order for the sealing lip to be capable of extending across the gap it has to project laterally from the exposed upper face of the body and it is usual practice to manufacture the combined fire and smoke seal with the sealing lip in this, operative, lateral position relative to the upper face of the support body.

With the sealing lip in this operative position, it is difficult to package the combined fire and smoke seals for transport/storage without potentially damaging the sealing lip. In particular it is difficult to stack lengths of the combined seals one on top of the other with their upper and lower faces in contact since to do so necessarily causes the sealing lips to be deflected. This is particularly so should the combined seal be wound into a roll for storage.

### SUMMARY OF THE INVENTION

According to one aspect of the present invention there is provided a gas seal for providing a seal between a frame and a movable member mounted on the frame, the gas seal comprising an elongate support member having opposed upper and lower faces and opposed first and second sides, and a sealing lip having an anchor portion and a sealing portion located in-between a pair of opposed side edges of the sealing lip, a first of said edges being connected to said support member and a second of said edges defining a terminal sealing edge of said sealing lip, the sealing lip normally residing in an inoperative position and being movable relative to the support member to an operative position, said anchor and sealing portions extending laterally from the first side when the sealing lip resides in said inoperative position whereas when the sealing lip resides in said operative position said anchor portion resides in face to face contact with said first side with said seal portion projecting laterally beyond the upper face of said support member

According to another aspect of the present invention there is provided a method of forming a seal between a frame and a movable member mounted on the frame, the method comprising forming a groove in said frame or movable member and locating a gas seal as defined above within the groove with the lower face of the support member adjacent to the bottom of the groove so as to trap said anchor portion of the sealing lip between a side of the groove and the opposed side of the support member.

### BRIEF DESCRIPTION OF THE DRAWINGS

Various aspects of the present invention are hereinafter described with reference to the accompanying drawings, in which:

FIG. 1 is a cross sectional view of a first embodiment according to the present invention shown in its as manufactured condition;

FIG. 2 is a cross sectional view of the first embodiment shown in use;

FIG. 3 is a cross sectional view of a second embodiment of the present invention shown in use;

FIG. 4 is a cross sectional view of a third embodiment of the present invention shown in its as manufactured condition;

FIG. 5 is a cross sectional view of the third embodiment shown in use;

FIG. 6 is a cross-sectional view of a fourth embodiment according to the present invention shown in its manufactured condition; and

FIG. 7 is a cross-sectional view of a fifth embodiment according to the present invention shown in its manufactured condition.

### DETAILED DESCRIPTION OF THE INVENTION

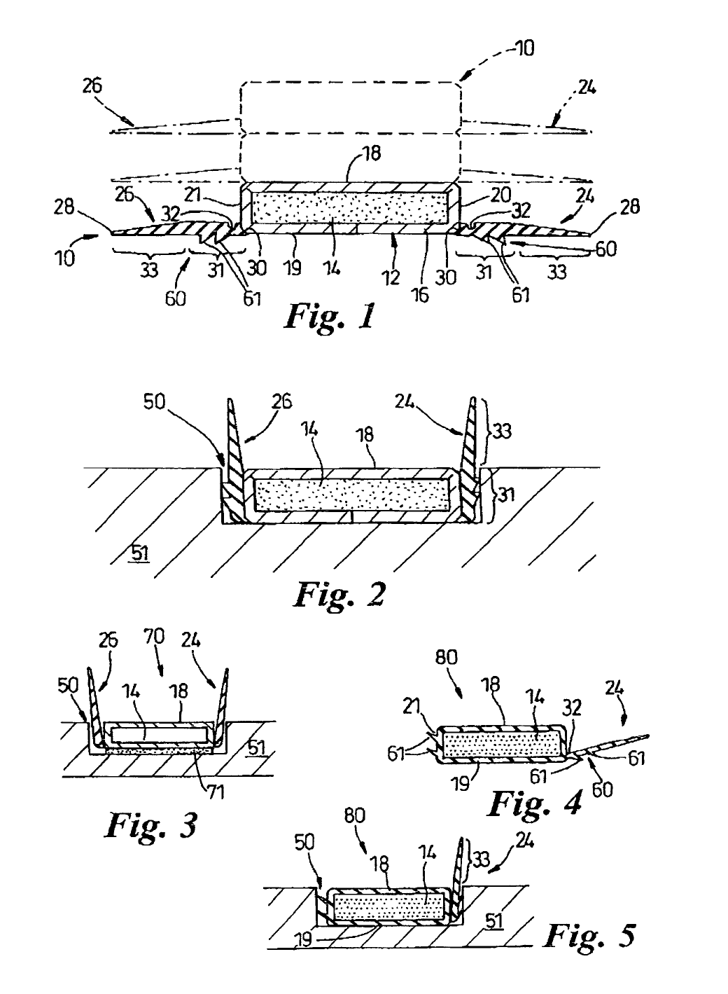

Referring initially to FIGS. 1 and 2 there is shown a combined fire and smoke seal 10 according to a first embodiment of the present invention.

The seal 10 includes an elongate support member 12 comprising a solid core of intumescent material 14 encased in a hollow body 16. The hollow body 16 defines the outer shape of the support member 12 which comprises an upper face 18, a lower face 19, a first side 20 and a second side 21. The hollow body 16 is preferably formed from a plastics material such as polyvinyl chloride. The hollow body 16 may be extruded as a tube to form the hollow body or may be extruded as a flat strip which is subsequently wrapped to form the hollow body.

Preferably the intumescent material 14 is co-extruded with the hollow body 16. Preferably the intumescent material is relatively flexible and consists of intercalated graphite flakes in a matrix of polyvinyl chloride. The polyvinyl chloride may be flexible or rigid.

A pair of sealing lips 24, 26 are provided each of which is of identical construction. Each lip 24, 26 is preferably formed from a thermoplastic elastomer such as ALCRYN (RTM) and has a first edge 28 which defines the terminal edge of the lip and a second edge 30 which is connected to the body 16. Located between the edges 28, 30 is an anchor portion 31 and a sealing portion 33.

Preferably the lips 24, 26 are co-extruded with the tube or flat strip which forms the hollow body so as to create an integral connection.

Preferably as illustrated in FIG. 1, during extrusion of each lip 24, 26 a groove 32 is created to define a hinge to facilitate bending of each lip relative to the body 16.

As shown in FIG. 1, the seal 10 is in its as manufactured condition wherein each lip 24, 26 projects laterally from respective sides 20, 21. In this condition, the lips reside in an inoperative sealing position which facilitates packaging of the seal 10.

In this respect, since the lips 24, 26 project laterally from the respective sides of the hollow body 16, it is possible to stack seals 10 one on top of the other (as shown in broken lines in FIG. 1) with their upper and lower faces 18,19 in face to face contact without deflecting the lips 24, 26. This enables lengths of the seal 10 (e.g. 1 to 3 meter lengths ) to be cut and stored in stacks, or if the support member 12 is sufficiently flexible, enable long lengths of the seal 10 (e.g. 100 meter lengths) to be wound into a roll.

In use, the seal 10 is located in a groove 50 as shown in FIG. 2. The groove 50 is formed for example in a frame 51 (or a movable member such as a door mounted on the frame). As seen in FIG. 2, when the seal 10 is located within the groove 50, each lip 24, 26 is moved relative to the body 16 to an operative position whereat the anchor portion 31 is trapped between a side of the groove 50 and the opposed side of the hollow body 16 and so holds or anchors the lip in its operative position. In this position, the inner face of the anchor portion 31 lies in face to face contact with the respective side 20 or 21 and the sealing portion 33 projects laterally beyond the upper face 18 of the body 16. By being trapped in-between opposed sides of the hollow body and groove 50, the anchor portion 31 provides a strong support for the sealing portion 33 and serves to isolate the connection between the lip and the body 16 from stresses created during use by repeated deflections of the sealing lip.

Preferably as illustrated in FIG. 1, the outer face of the anchor portion 31 is provided face engagement means 60, preferably in the form of integrally extruded ribs 61, which are placed under compression when the seal is located in the groove 50 and so act to engage the facing side of groove 50 in order to restrain removal of the seal 10 from the groove 50. The enables the seat 10 to be located in a groove 50 without the use of additional means such as adhesive.

A second embodiment 70 is illustrated in FIG. 3 which is of the same construction as the first embodiment 10 except that the engagement means 60 are not provided. In the second embodiment 70, the seal is retained within the groove 50 by means of an adhesive, such as a doubled sided pressure sensitive adhesive tape 71, located between the lower face 19 of the body 16 and the bottom of groove 50.

A third embodiment 80 is illustrated in FIGS. 4 and 5. The third embodiment 80 differs from the first embodiment 10 in three respects, viz. (i) only one sealing lip 24 is provided, (ii) the body 16 and sealing lip 24 are integrally formed from the same elastomer and (iii) engagement ribs 61 are formed on the second side 21 of the body 16.

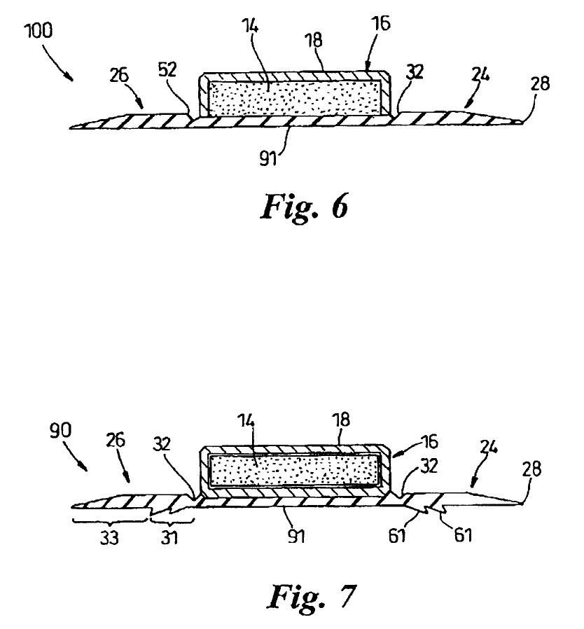

A fourth embodiment 90 is illustrated in FIG. 6; components similar to those in the previous embodiments have been illustrated by the same reference numerals.

In embodiment 90 the sealing lips 24, 26 are integrally joined by an intermediate planar strip-like body portion 91 which is bonded in face to face contact with the lower face 19 of body 16. As in previous embodiments, face engagement means 60 are optionally provided and if desired only one lip 24 or 26 need be provided.

An advantage of providing the strip-like body portion 91 is that a more secure connection between the lips 24, 26 and body 16 is provided since the lips 24, 26 form an integral extension of the body portion 91 and so connection of the lips 24, 26 is not solely reliant upon second edges 30 being bonded to the body 16, i.e. body portion 91 provides surface area for bonding with the body 16.

The fifth embodiment 100 shown in FIG. 7 is similar to the embodiment of FIG. 6 except that the body portion 91 forms part of the body 16 by replacing the lower wall of body 16.

Although not shown in FIG. 7, it will be appreciated that lips 24, 26 may be provided with face engagement means 60.

In the embodiments of FIGS. 6 and 7, the lips 24, 26 and body portion 91 are co-extruded from suitable elastomer and may be co-extruded with the body 16 so as to be integrally bonded thereto.

In the above embodiments, the sealing lips 24, 26 are preferably formed from a thermoplastic elastomer. It will be appreciated that other flexible/resilient materials may be used provided that they may be bonded to the material forming the hollow body 16.

In the above embodiments, the body 16 contains a core of intumescent material 14 so as to act as a fire seal.

Provision of the intumescent material 14 is optional.

If a core of intumescent material 14 is not provided, the seal will act as a smoke (or gas) seal only. In such a case, the depth or thickness of body 16 may be reduced. However, the thickness of body 16 should be such to provide sufficient height for sides 20, 21 to enable the anchor portion 31 to be trapped between opposed sides of the body 16 and groove 50 and act to anchor respective lips 24, 26 in their operative position.

What is claimed as the invention is:

1. A gas seal for providing a seal between a frame and a movable member mounted on the frame, the gas seal comprising an elongate support member having opposed upper and lower faces and opposed first and second sides, and a sealing lip extending along and being joined to the support member, the sealing lip having an anchor portion and a sealing portion, the sealing portion being spaced from the support member by said anchor portion and having an edge which defines a terminal sealing edge of said sealing lip, the sealing lip normally residing in an inoperative position and being movable relative to the support member to an operative position, said anchor and sealing portions extending laterally from the first side when the sealing lip resides in said inoperative position whereas when the sealing lip resides in said operative position said anchor portion resides in face to face contact with said first side with said seal portion projecting laterally beyond the upper face of said support member.

2. A gas seal according to claim 1 wherein said sealing lip is formed from an elastomer.

3. A gas seal according to claim 1 wherein said anchor portion is hingedly connected to said first side.

4. A gas seal according to claim 1 wherein said support member is formed from a plastics material.

5. A gas seal according to claim 1 wherein the support member is formed from a plastics material or an elastomer and the sealing lip is formed from an elastomer, the support member and scaling lip being co-extruded so as to be integrally connected.

6. A gas seal according to claim 5 wherein said sealing lip is co-extruded with a planar strip-like body which is bonded to the lower face of said support member.

7. A gas seal according to claim 5 wherein said sealing lip is coextended with a planar strip-like body which forms part of said support member to define said lower face of the support member.

8. A gas seal according to claim 5 wherein the sealing lip is extruded to define a hinge spaced from said first side to enable the sealing lip to move relative to the support member between said inoperative and operative positions.

9. A gas seal according to claim 1 wherein said anchor portion has an inner face and an outer face, said inner face being in face to face contact with the first side when said sealing lip is in said operative position, said outer face being provided with face engagement means which, in use, are engagable with a side of a groove formed in said frame or movable member to retain said gas seal within said groove.

10. A gas seal according to claim 1 wherein a further sealing lip as defined in claim 1 is provided, the further sealing lip being located adjacent to said second side of the support member.

11. A gas seal according to claim 1 wherein said support member is a fire seal.

12. A gas seal according to claim 1 wherein said support member comprises an intumescent material encased in a hollow body.

13. A method of forming a seal between a frame and a movable member mounted on the frame, the method comprising forming a groove in said frame or movable member and locating a gas seal according to claim 1 within the groove with the lower face of the support member adjacent to the bottom of the groove so as to trap said anchor portion of the or each sealing lip between a side of the groove and the opposed side of the support member.
